(19) United States
(12) Patent Application Publication
(10) Pub. No.: US 2012/0317714 A1
(43) Pub. Date: Dec. 20, 2012

(54) DEVICE AND METHOD FOR THE LATERAL POSITIONING OF PERSONS

(76) Inventor: Ralf Matschurek, Peine (DE)

(21) Appl. No.: 13/522,869

(22) PCT Filed: Feb. 11, 2011
(86) PCT No.: PCT/EP2011/000653

§ 371 Date: Aug. 27, 2012

(30) Foreign Application Priority Data
Feb. 17, 2010 (DE) 10 2010 008 358.5

(51) Int. Cl. A61G 7/00

(52) U.S. Cl. 5/81.1 RP; 5/81.1 R

(57) ABSTRACT

The invention relates to a lateral positioning device for the variable lateral positioning of a recumbent person (6), having the following features: at least one actuator (4, 8, 10, 12, 13, 14, 92, 93, 94, 95, 96) acting on a resting surface (5) for the person (6), wherein, by means of the actuator (4, 8, 10, 12, 13, 14, 92, 93, 94, 95, 96), the angle (α_{L}, α_{R}) between the transverse axis (Q) of the resting surface (5) and the horizontal (H) can be varied, at least one sensor (7, 9) having an output signal which represents the respective angle (α_{L}, α_{R}) between the transverse axis (Q) and the horizontal (H), and at least one electronic control device (11) which is connected to the sensor (7, 9) and the actuator (4, 8, 10, 12, 13, 14, 92, 93, 94, 95, 96, 97) and is equipped i) to determine an actual inclined position from the output signal of the sensor (7, 9), ii) to adjust the angle (α_{L}, α_{R}) between the transverse axis (Q) of the resting surface (5) and the horizontal (H) by actuating the actuator such that the actual inclined position is set to a predetermined target inclined position. The invention further relates to a method for the variable lateral positioning of a recumbent person.

The invention relates to a lateral positioning device for the variable lateral positioning of a recumbent person as claimed in claim 1. The invention further relates to a method for the variable lateral positioning of a recumbent person as claimed in claim 12.

The invention generally concerns the field of decubitus prophylaxis and decubitus therapy in persons who are recumbent for long periods of time. In this field, “alternating pressure mattresses” have long been known, in which the distribution of pressure in the mattress and therefore the contact pressure at the individual points of the body of a person recumbent on the mattress (also referred to hereinafter as a patient) is varied. For example, such a system is known from DE 40 23 289 C2. However, more recent findings indicate that the frequently changing distribution of pressure to which the patient's body is exposed can also be associated with disadvantages. For example, some patients complain of disorientation as a result of the changing distributions of pressure. The latest findings therefore propose laterally repositioning the patient more frequently and thus preventing undesirable pressure sores over the patient's body. However, the manual repositioning of a patient by carers has the disadvantage of being associated with a relatively high level of physical exertion on the part of the carer and can be harmful to the carer's health.

The object of the invention is therefore to provide an improved device, with which effective decubitus prophylaxis and decubitus therapy is possible. A further object of the invention is to provide an advantageous method for this purpose.

This object is achieved by the invention disclosed in claims 1 and 12. The dependent claims disclose advantageous developments of the invention.

In accordance with the invention, a lateral positioning device for the variable lateral positioning of a recumbent person is proposed and has the following features:
at least one actuator acting on a lying surface for the person, wherein, by means of the actuator, the angle between the transverse axis of the lying surface and the horizontal can be varied,
at least one sensor having an output signal, which represents the respective angle between the transverse axis and the horizontal,
at least one electronic control device, which is connected to the sensor and to the actuator and is designed
   i) to determine an actual inclined position from the output signal of the sensor,
   ii) to adjust the angle between the transverse axis of the lying surface and the horizontal by actuating the actuator in such a way that the actual inclined position is set to a predetermined target inclined position.

Such a system advantageously allows automatic repositioning of a recumbent person from one lateral position into the other or from a supine position into a lateral position and accordingly back into the supine position. The exact lateral inclined position of the lying surface and therefore of the recumbent person can be detected by use of at least one sensor. The sensor detects a measure, which represents the respective angle between the transverse axis of the lying surface and the horizontal, that is to say it makes it possible to establish the angle. The inclined position can therefore be set to a desired, therapeutically inclined value via an electronic control of the actuator. To this end, the current inclined position is determined in an electronic control device, is compared to a predetermined target inclined position and, as a result, the current inclined position is set to the predetermined target inclined position by corresponding actuation of the actuator.

The current inclined position of the lying surface is advantageously determined. In this case, any measure specifying the lateral inclined position of the lying surface and detectable by a sensor is understood to be an inclined position, for example the vertical distance between a reference point of the lying surface and an associated reference point of a horizontal reference surface, or the respective angle between the transverse axis of the lying surface and the horizontal. A sensor which is adapted to detect a measure representing the respective angle between the transverse axis of the lying surface and the horizontal is required.

The electronic control device can establish the inclined position directly as the angle between the transverse axis of the lying surface and the horizontal. The electronic control device can establish the inclined position internally, as well as other variables, and can compare it to a corresponding target value.

The inclined position of the lying surface and therefore of the person recumbent on the lying surface can thus be controlled by means of the invention. This has the advantage that the desired inclined position of the patient can be set in a highly precise manner, since feedback regarding the actual inclined position can be provided via the sensor. In addition, the reproducibility of the required inclined position of the patient during a repositioning operation can be improved considerably. The lateral positioning device according to the invention is therefore to be operated with the aforementioned high level of reproducibility of the inclined position independently of specific patient characteristics, for example the weight of the patient and of the care bed. Due to the feedback via the sensor, such environmental parameters do not have a decisive influence on the precise and reproducible setting of the inclined position.

A further advantage is that the lateral positioning device according to the invention is particularly well adapted to be retrofitted to existing care beds, wherein, in principle, attachment is possible to any care bed. In particular, the lateral positioning device according to the invention can thus be used universally.

In principle, the sensor can be any type of sensor which makes it possible to determine the inclined position of the lying surface and which therefore makes it possible, either directly or indirectly, to determine the actual angle. For example, an angle sensor measuring the angle directly can thus be used, for example a potentiometric sensor. The inclined position of the lying surface may advantageously also be determined by means of a sensor detecting the vertical distance from a reference point of the lying surface to an associated reference point of a horizontal reference surface. In this case, the sensor may be formed as a distance sensor, for example as a path sensor. For example, an ultrasonic sensor or a capacitive sensor may advantageously be used. The inclined position of the lying surface, and therefore the actual inclined position, can be determined by the measurement of the vertical distance between the reference points in conjunction with further geometrical data of the arrangement.

In accordance with the invention, the sensor is formed as an acceleration sensor. This makes it possible to detect the actual inclined position in a particularly simple and cost-effective manner on the basis of the acceleration signal output by the sensor. The output acceleration signal corresponds to a proportion of the acceleration of gravity, which, as a result of the changing inclined position of the lying surface, likewise changes in accordance with a cosine function. This makes it possible to determine the actual inclined position easily and quickly. The use of an acceleration sensor has the further advantage that the sensor can be obtained in relatively small design and can therefore be attached easily to a care bed.

In accordance with the invention, a first sensor having an output signal representing the respective angle when the lying surface is rotated to the left and a second sensor having an output signal representing the respective angle when the lying surface is located to the right are provided. This has the advantage that the inclined position can be detected in a highly accurate manner, even in arrangements in which a rigid lying surface is not provided or in which the lying surface is not pivoted as a whole by the actuator. In particular, an actuator may advantageously be used, with which the left-hand side and the right-hand side of the lying surface can be raised separately from one another, for example a two-chamber air chamber system.

In principle, the actuator can be any type of actuator which is suitable for pivoting the lying surface laterally, that is to say for changing the angle to the longitudinal axis of the lying surface. For example, hydraulically or pneumatically actuated actuating cylinders, electric motor drives or hydraulically or pneumatically fillable flexible chamber systems are suitable. In accordance with the invention, the actuator has at least one inflatable air bellows and at least one pump for feeding air into the air bellows. The use of an air bellows, which may have one or more chambers, has the advantage that the actuator can be easily retrofitted to an existing care bed, for example by attachment between the slatted frame and the mattress. The use of compressed air as a medium for filling the bellows is advantageously environmentally friendly and is not harmful to health. A flexible air bellows also has the advantage that it adapts flexibly to the shape of the patient's body and to the surrounding parts of the care bed. In addition, the inclined position of the patient can be varied gently via a compressed air control system, which has the advantage that the patient's sleep is not disturbed. In an advantageous embodiment, a largely silent pump is used, for example a diaphragm pump. The pump is advantageously suspended from the bed frame in a freely oscillating manner, thus further minimizing noise emissions. In addition, the transfer of disruptive oscillations to the bed frame is minimized.

In accordance with the invention, the sensor is arranged between the lying surface and the actuator. This enables simple and effective attachment of the sensor. The sensor can advantageously be integrated with other components. For example, the sensor can thus be integrated in the actuator, for example in the air bellows. The sensor can also be integrated in the mattress of the care bed. For example, the sensor can also be attached by a belt drawn over the air bellows or the mattress. The sensor or sensors is/are advantageously arranged approximately at shoulder height of the patient. In accordance with a further advantageous possible arrangement of the sensors, these are sewn into a cover, which is drawn over the air bellows.

In accordance with an advantageous development of the invention, the sensor additionally generates an output signal which represents the respective angle of the longitudinal axis of the lying surface relative to the horizontal. The sensor may advantageously be formed as a multi-axis acceleration sensor. With use of only one sensor module, the inclined position in the longitudinal direction, that is to say relative to the transverse axis, can thus also advantageously be taken into consideration by the electronic control device. For example, in the case of a care bed having a variably adjustable backrest, the respective inclined position of the backrest can thus be detected. If the electronic control device recognizes, on the basis of the output signal, that a specific inclined position of the backrest has been reached or exceeded, an actuation of the actuator to increase the actual inclined position in the transverse direction is disabled, or the actual inclined position in the transverse direction is reduced. An undesirable tipping over of the patient can thus be prevented.

In accordance with an advantageous development of the invention, the air bellows has a stabilizing plate in a region of each of the left and right air chambers, said regions being provided for the arrangement of the first and second sensor. The stabilizing plates can be formed either as individual, separate plates or as one continuous plate. The plates can also be interconnected in a hinged manner. The stabilizing plates advantageously increase the field of application of the lateral positioning device according to the invention to practically any design of care bed. No specific requirements have to be met in terms of size, shape and rigidity of the slatted frame or of the bed frame. Due to the stabilizing plates in the region of the left and right sensor, a defined contact area for the sensors is created so that they can supply reproducible data practically independently of the design of the bed used. In addition, the calibration capability of the sensor to a zero position is improved. In accordance with an advantageous embodiment, the stabilizing plates are formed as rigid foam plates. In this case, the stabilizing plates may also contain further constituents, wherein at least one rigid foam layer is provided however.

In accordance with an advantageous development of the invention, the stabilizing plates are arranged on the side of the air bellows facing the slatted frame of the care bed. The stabilizing plates are thus arranged on a side of the air bellows remote from the side of the air bellows on which the first and second sensor are arranged. The stabilizing plates thus allow defined calibration of the zero position of the actual inclined position detected by the sensors when the respective air chamber is substantially free from overpressure and thus lies flat.

In principle, the stabilizing plates can be connected in any manner to the air bellows. In accordance with an advantageous development of the invention, a non-releasable connection is provided for this purpose, for example by means of adhesive bonding. In accordance with a further advantageous development of the invention, the stabilizing plates are incorporated into the material of the air bellows, for example by vulcanization. The rigid connection of the stabilizing plates to the air bellows has the advantage that the stabilizing plates are already arranged in the correct position at the time of production, and therefore the stabilizing plates are positioned correctly, without further measures, when the lateral positioning device is attached in a care bed.

In accordance with an advantageous development of the invention, the pump is designed to suck air from the left air chamber and from the right air chamber. This has the advantage that the respective air chamber can be emptied actively by the pump so that the degree of emptying and the speed of emptying do not depend on the weight acting on the air chamber. Even an unloaded lateral positioning device can thus be de-aerated safely. In addition, de-aeration of the air chambers is not dependent on the weight of the patient situated thereon, and therefore the same, defined de-aeration times and gradients can always be achieved, independently of patient weight. In particular, the air chamber can be emptied completely. This provides the further advantage that the lateral positioning device does not have to be specified for specific minimum patient weights. Rather, the lateral positioning device can be used for any patient.

In accordance with an advantageous development of the invention, the pump is connectable via its compressed air delivery side by means of a respective electrically actuatable inlet valve to the left and right air chamber. In addition, the pump is connectable via its intake side by means of a respective electrically actuatable outlet valve to the right and left air chamber. This has the advantage that any filling and suction states can be set by the different valves, and therefore the pump can be used selectively to fill an air chamber or to empty an air chamber. Depending on the valve arrangement, simultaneous filling of both air chambers or simultaneous emptying of both air chambers is also possible. It is likewise possible to fill the air sucked from one air chamber into the other air chamber. In accordance with an advantageous development of the invention, the intake side of the pump is connectable via a further electrically actuatable valve to the atmosphere. In accordance with a further advantageous development of the invention, the compressed air delivery side of the pump is connectable via an electrically actuatable valve to the atmosphere. Due to the valves connected to the atmosphere, air can be exchanged with the environment as desired when filling and emptying the air chambers.

In accordance with an advantageous development of the invention, the electrically actuatable valves are formed as 2/2 valves.

In accordance with an advantageous development of the invention, the electrically actuatable valves are formed as 3/2 valves. In an advantageous embodiment of the invention, three electrically actuatable 3/2 valves are combined to form a valve block, in which the 3/2 valves are connected pneumatically in series in such a way that the valve block has a connection point provided for connection to the pump, said connection point being connected to a first of the 3/2 valves. This valve is connected to a second 3/2 valve, which is in turn connected to the third 3/2 valve. In each case, one connection point of the first and of the third 3/2 valve of a valve block is provided for connection to an air chamber of the air bellows. A connection point of the second, middle 3/2 valve is provided for connection to the atmosphere.

The aforementioned electrically actuatable valves can be actuated by the electronic control device.

In accordance with an advantageous development of the invention, the electronic control device and the pump are formed as a one-part electromechanical unit with a common housing. The electrically actuatable valves may also be arranged additionally in the common housing. This makes it possible to construct the lateral positioning device in a very compact manner. In addition to the air bellows, which is to be arranged in the region of the lying surface, and in addition to the sensors, which are provided in the region of the air bellows, merely the one-part electromechanical unit is additionally to be attached to the care bed. This enables simple and quick attachment of the lateral positioning device to a care bed. In particular, a user does not have to make a large number of individual pneumatic connections between the pump, the electrically actuatable valves and the air chambers. Merely the two separate compressed air connections to the air chambers are to be connected.

In accordance with an advantageous development of the invention, the first and/or the second sensor is/are fixed releasably to the surface of the air bellows. For example, they may be fastened by means of a hook-and-loop fastener fixed on the air bellows. This enables simple accurate positioning of the sensors at the desired location and adaptation of the position of the sensors to the size of the patient's body.

In accordance with an advantageous development of the invention, the air bellows has fastening areas for the first and second sensor, said fastening areas being arranged in the region of the shoulders of a patient recumbent on the mattress of a care bed. Due to the positioning of the sensors in the region of the patient's shoulders, the actual inclined position can be established in an expedient and practice-oriented manner. In an advantageous embodiment, the fastening areas are provided with the above-mentioned hook-and-loop fastener, for example with a hook-and-loop strip. For example, the sensors can be adjusted to the width of the patient's shoulders.

In accordance with an advantageous development of the invention, the air chambers extend in the longitudinal direction of the mattress over the shoulder and torso region of a patient, but not as far as the region of the lower legs. In accordance with an advantageous development of the invention, the air chambers also do not extend as far as the region of the patient's legs. Both developments have the advantage that a patient is not moved to the side completely, that is to say with his entire body, but only the shoulder and torso region as well as the head are moved. The patient's entire body is thus prevented from slipping to the side once a specific inclined position has been reached. In particular, the legs are prevented from slipping away laterally. In addition, an uncomfortable feeling of a lateral transverse force, which a patient intuitively attempts to counterbalance, is prevented. On the whole, a more comfortable lateral positioning can thus be achieved compared to systems in which the entire bed frame is moved laterally.

An advantageous lateral positioning device can thus be produced, which can be used independently of a patient's weight and is also suitable for patients weighing up to 300 kg. In addition, the inclined position of the head part of the bed can be monitored, thus preventing a recumbent patient from falling forwards in an undesirable manner. A significant advantage of the lateral positioning device according to the invention is the possibility of using existing care mattresses, in particular relatively expensive soft care mattresses and high-weight mattresses. The air chamber system of the air bellows can be provided in different embodiments. An air bellows of increased width can thus be provided for extremely broad patients. At the same time, extremely light persons can also be repositioned by means of the lateral positioning device according to the invention. The lateral positioning device allows the air chambers to be filled gently and slowly, which makes it possible to reposition patients in a very comfortable manner, in particular patients who are in pain.

An advantageous method for variable lateral positioning of a recumbent person has the following steps:
a) specification of a target inclined position relative to the transverse axis of a lying surface of the person and the horizontal,
b) actuation of an actuator to change the angle between the transverse axis of the lying surface and the horizontal,
c) determination of a current inclined position from the output signal of a sensor, wherein the output signal represents the respective angle between the transverse axis and the horizontal,
d) termination of the actuator actuation when the current inclined position has reached the target inclined position.

In accordance with the invention, the target inclined position can be stored in an electronic control device in a learning mode. For example, in the learning mode, a career can set a desired inclined position by means of manual actuation of the actuator and can communicate this inclined position as a desired target inclined position to the electronic control device, for example by actuation of a button. The electronic control device then stores the target inclined position and henceforth uses the target inclined position for automatic repositioning of the patient.

Such a method advantageously makes it possible to set a desired inclined position in a defined manner with highly accurate reproducibility.

In accordance with an advantageous development of the invention, the person is automatically repositioned from one side to the other side by means of temporal control. A specific lateral position time can advantageously be selected, for example 30, 60, 90 or 120 min. Once the time has elapsed, the electronic control device then automatically repositions the patient into the opposite lateral position by actuation of the actuator. Continuous repositioning is thus ensured. Reliable decubitus prophylaxis is thus possible as well as decubitus therapy up to decubitus level 4.

In accordance with an advantageous development of the invention, the target inclined position is automatically varied within a predefined range starting from a start value. With automatic repositioning, different inclined positions can thus be set, which has the advantage that different regions of a patient's body can be relieved of pressure. The target inclined positions can be determined in particular in accordance with a random pattern.

In accordance with an advantageous development of the invention, the inclined position set by the actuator is automatically limited to a maximum value. An undesirable tipping over of the patient laterally can thus be prevented.

In accordance with an advantageous development of the invention, the control device automatically sets, within predefined limit values, different target inclined positions having different position times. In particular, the target inclined positions and/or the position times, which are set automatically by the control device, can be determined by means of a random number generator. For example, values from 0 degrees as a lower limit value and 15 degrees as an upper limit value can be used as limit values for the target inclined positions. For example, 30 minutes as a lower limit value and 60 minutes as an upper limit value can be used as limit values for the position time.

For example, the random number generator can be implemented in the control device in the form of a pseudo random number generator by means of software programming.

In accordance with an advantageous development of the invention, a settable starting position of the target inclined position can be programmed. The control device re-sets the starting position by means of the actuator after a predefined time after a manual change to the target inclined position, which can be input for example via an operating means. Changes to the target inclined position made by the patient himself are thus changed again automatically into a desired starting position after a specific time.

In accordance with an advantageous development of the invention, an intensive program is provided in the control device and is designed for use in intensive care. In the intensive program, the control device only actuates the actuator as a result of manual actuations at an operating means of the lateral positioning device. Automatic repositioning does not occur in this mode. The lateral positioning device is thus also advantageously suitable for use in an intensive care unit when manual repositioning controlled by an operating means is necessary, for example for patients with ventilation support or for patients with drainage support.

The lateral positioning device may have one or more switches or buttons as operating means. The operating means are advantageously integrated in the housing in which the control device and the pump are provided.

Further advantages of the invention are:
a) pressure relief over a large area
b) healing of existing decubiti
c) no disruption to sleep
d) quiet
e) even heavy patients are repositioned gently, which has advantages for the health of the carer
f) sense of orientation is retained completely, since the patient can always lie on his back on a soft care mattress
g) gentle positioning even for heavy patients, which leaves carers with more time to provide other care
h) promotion of the microclimate and of circulation
i) robust, durable and reliable.

The invention will be explained in greater detail hereinafter on the basis of exemplary embodiments with use of drawings, in which:

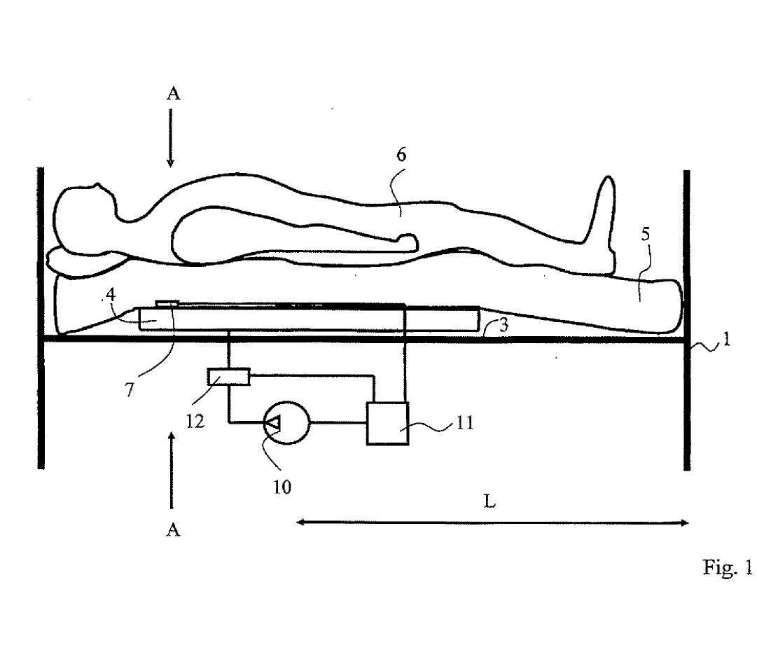

FIG. 1 shows a lateral illustration of a care bed and

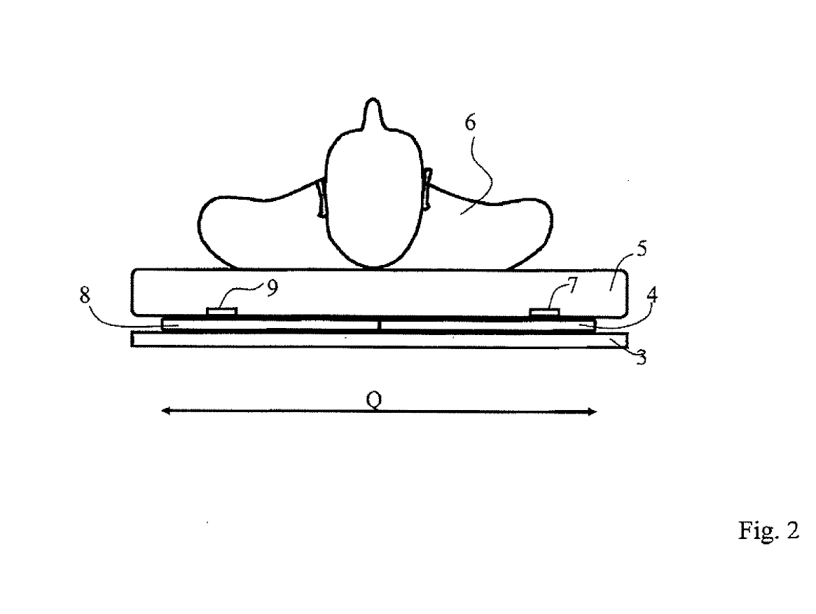

FIGS. 2 to 4 show a cross-section of the care bed according to FIG. 1, taken along the line A-A and

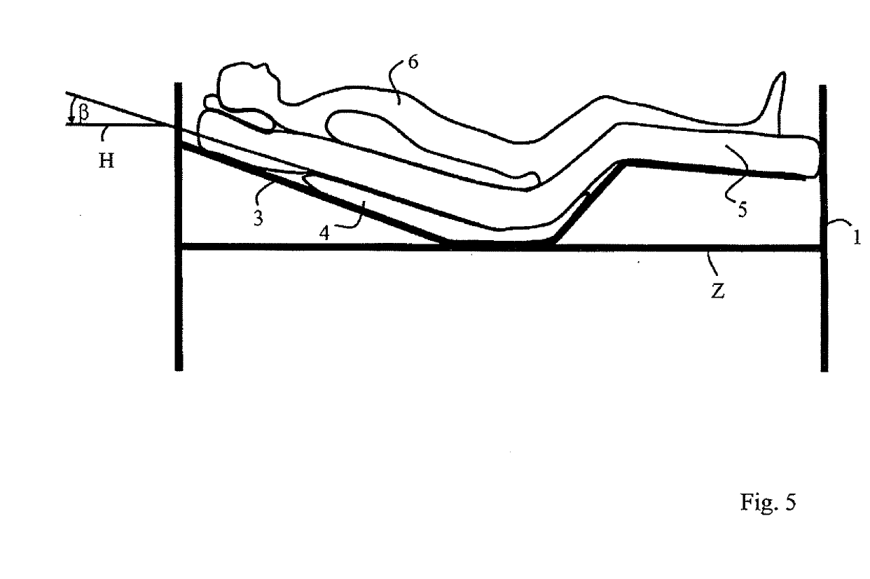

FIG. 5 shows a side view of a further care bed and

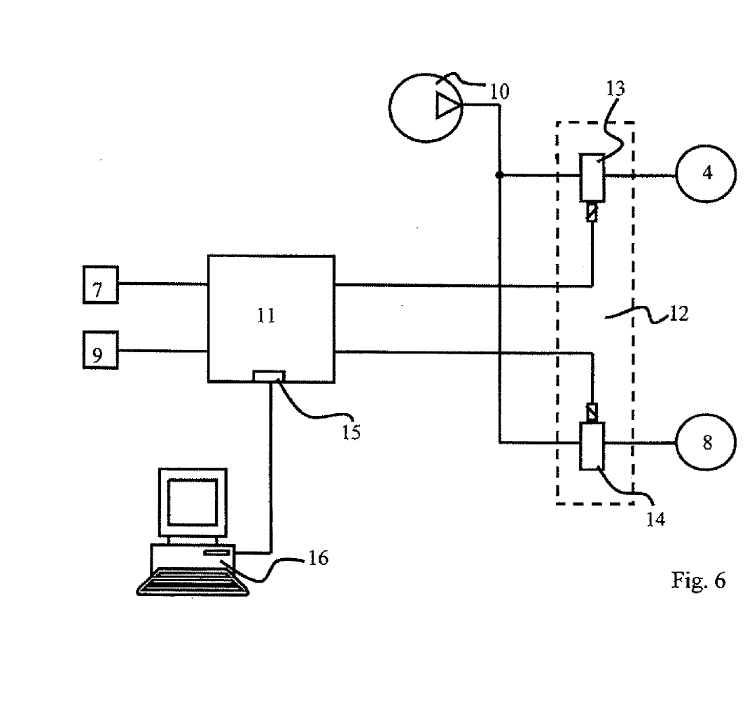

FIG. 6 shows a schematic illustration of a lateral positioning device

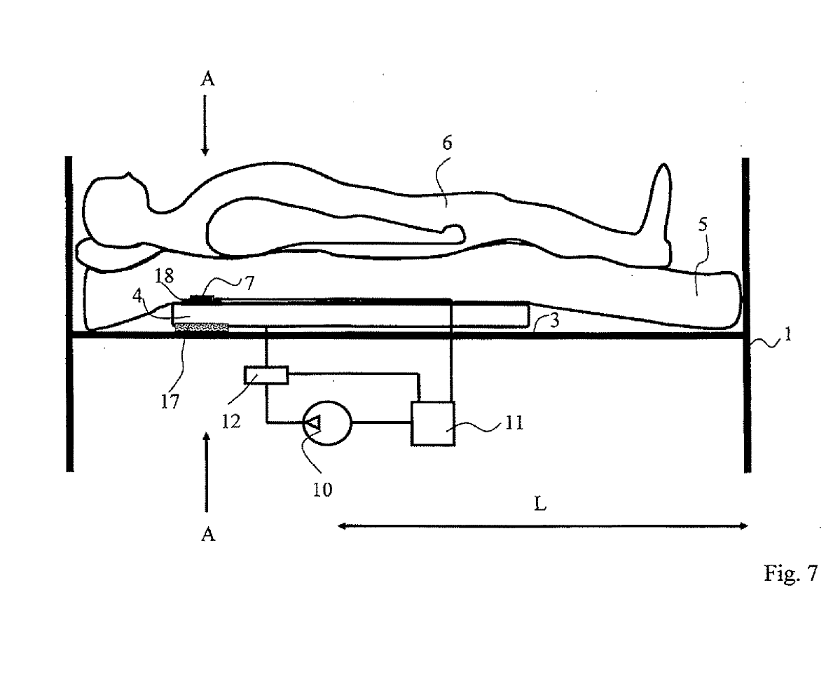

FIG. 7 shows a lateral illustration of a care bed with a further embodiment of the lateral positioning device and

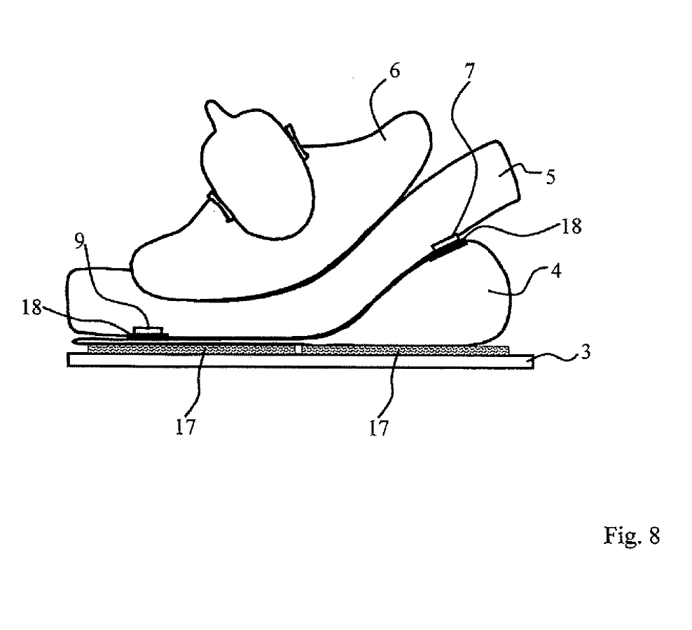

FIG. 8 shows a cross-section of the care bed according to FIG. 7, taken along the line A-A and

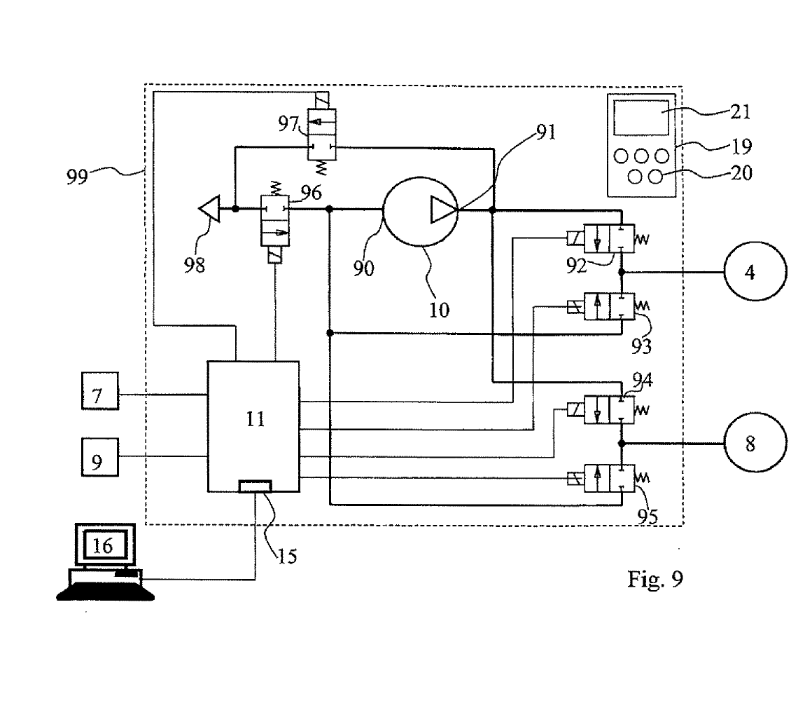

FIG. 9 shows a schematic illustration of a further embodiment of the lateral positioning device and

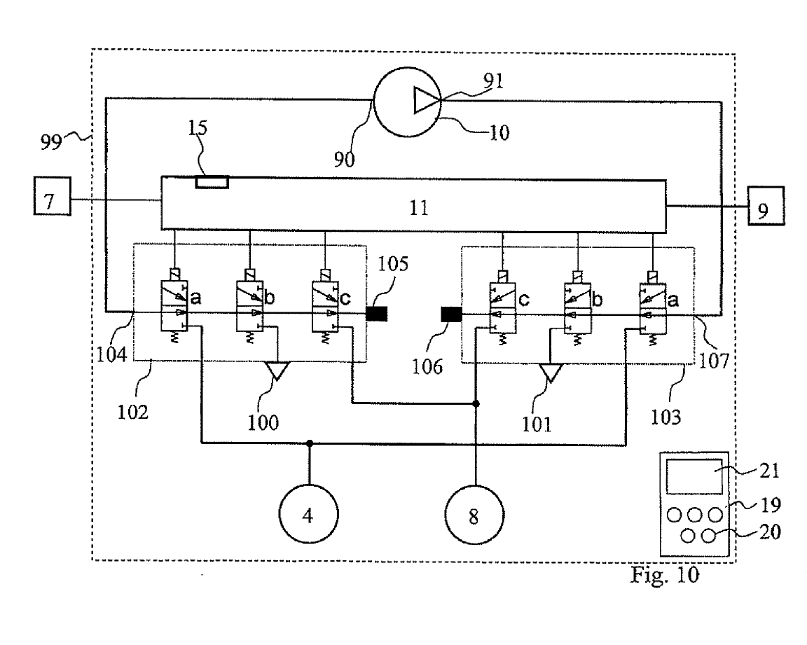

FIG. 10 shows a schematic illustration of a further embodiment of the lateral positioning device.

In the figures, like reference signs are used for corresponding elements.

FIG. 1 shows a care bed 1 having a horizontal bed frame 2. A slatted frame 3 is arranged on the bed frame 2. A mattress 5 is in turn arranged on the slatted frame 3. A recumbent person 6 is illustrated on the mattress 5. An air bellows 4 is arranged between the mattress 5 and the slatted frame 3 as part of the actuator. An acceleration sensor 7 is arranged on the upper face of the air bellows 4, below the mattress 5. An electronic control device 11 and, as further parts of the actuator, a pump 10 and a valve arrangement 12 are also illustrated highly schematically. The air bellows 4 is connected via a compressed air line to the valve arrangement 12 and via said valve arrangement to the pump 10. The acceleration sensor 7, the valve arrangement 12 and the pump 10 are connected via electrical lines to the electronic control device 11. The electronic control device 11 is designed to receive the output signal of the acceleration sensor 7. In addition, the electronic control device 11 is designed to control the valve arrangement 12 and the pump 10 by electric control signals. For example, the pump 10 can be formed as an electrically driven diaphragm pump. The pump 10 is designed to suck air from the atmosphere and to pump it via the valve arrangement 12 into the air bellows 4. The air bellows 4 can be connected selectively to the pump 10 or to the atmosphere via the valve arrangement 12, or can be shut off selectively with respect to the atmosphere and the pump 10. The amount of air in the air bellows 4 can thus be increased, kept constant, or reduced, controlled by the electronic control device 11.

FIG. 1 also shows the longitudinal axis L, which extends in the longitudinal direction of the care bed.

FIG. 2 shows a cross-section through the care bed 1 along the line A-A illustrated in FIG. 1. FIG. 2 also shows the transverse axis Q, which extends in the transverse direction of the lying surface. In this case, the mattress 5 represents the lying surface of the patient.

FIG. 2 shows an actuator comprising an air bellows, which has a right air chamber 4 and a left air chamber 8. The air chambers 4, 8 are connectable via separate compressed air lines and via the valve arrangement 12 to the pump 10 or the atmosphere. Furthermore, a second acceleration sensor 9 provided in the region of the left air chamber 8 is also provided in addition to the acceleration sensor 7 already mentioned, which is arranged in the region of the right air chamber 4. The inclined position of the lying surface can be detected by the acceleration sensor 7 in the event of rotation to the left. The inclined position of the lying surface can be detected by the second acceleration sensor 9 in the event of rotation to the right.

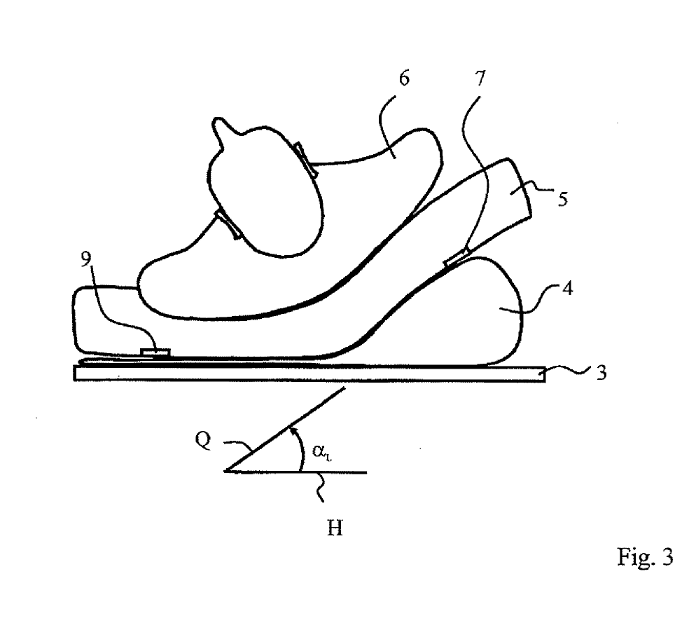

FIG. 3 shows the cross-section according to FIG. 2, wherein the lying surface has been rotated to the left by filling the air chamber 4 with an amount of air. As can be seen, the lying surface 5 has an inclined position, which is characterized by an angle o, which is formed between the transverse axis Q of the lying surface 5 and the horizontal H.

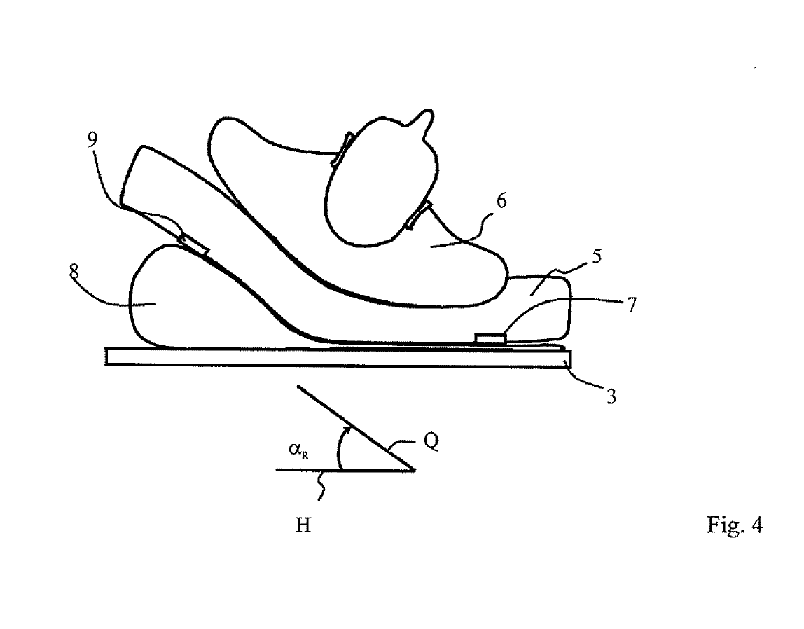

Similarly to FIG. 3, FIG. 4 shows the lying surface in the event of rotation to the right. The rotation to the right is implemented by filling the air bellows 8 with air. In this case, the air bellows 4 is deaerated. As can be seen, the inclined position of the lying surface is characterized by an angle α_{R}, which is formed between the transverse axis Q and the horizontal H.

FIG. 5 shows a further embodiment of the care bed 1, in which the lying surface 5 is adjustable in the longitudinal direction by an adjustable backrest region of the slatted frame 3. The respective inclined position set in the longitudinal direction is characterized by an angle β, which is formed between the longitudinal axis L and the horizontal H.

FIG. 6 shows a schematic illustration of the layout of a lateral positioning device. As can be seen, the electronic control device 11 is connected via electrical lines to the acceleration sensors 7, 9 and via further electrical lines to electrically actuatable pneumatic valves 13, 14 of the valve arrangement 12. For example, the pneumatic valves 13, 14 may have the following switching states with respect to the atmosphere, which can be set by electrical actuation: open, shut-off and de-aeration. The pump 10 is connected via compressed air lines via the pneumatic valves 13, 14 to the respective air chambers 4, 8.

In the event of a power failure, an alarm signal is triggered and/or the air chambers 4, 8 are automatically de-aerated. To this end, valves which are open currentlessly with respect to the atmosphere are used as pneumatic valves.

The invention is particularly suitable for immobile patients and for patients who are severely restricted in terms of mobility. With regard to the control process, a specific lateral position time of 30, 60, 90 or 120 minutes for example can be selected. The lateral positioning device brings the patient into a predetermined inclined position, for example a 30° lateral position, within a specific period of time, for example approximately 7 minutes. The patient then remains in the set inclined position for the previously selected lateral position time and is then repositioned gently into another lateral inclined position, for example into the opposite 30° inclined position, within approximately 15 minutes.

The air chambers 4, 8 and the other elements of the lateral positioning device can be incorporated in any care bed, preferably in care beds having sidebar protection. For example, the air chambers 4, 8 can be produced from polyurethane. The air chambers 4, 8 are installed between the slatted frame and the mattress 5 in accordance with an installation manual. The connection to the control device 11 and to the pump 10 is then made.

Further functions may be provided:

Specific lateral positioning programs (left-neutral-right, left-right, left-neutral, right-neutral (neutral means the supine position of the patient)) can be selected. The starting side can be selected during this process.

The lateral position times and the reposition times can be selected. For example, an interval of 10 minutes to 120 minutes can thus be set in 5-minute steps for the lateral position time. The lateral position time can be set separately for each position within a positioning program (left-neutral-right).

The reposition time, that is to say the time for the change from one inclined position into another, can be set. The reposition time should be approximately 7 minutes, but should not be less than 6 minutes however.

The repositioning operation can also be recorded automatically and evaluated by a computer program. The automatically compiled record of the repositioning operation can therefore advantageously be integrated in a simple manner into the care documentation. To this end, the control device 11 has an interface 15. The control device 11 can be connected to a computer 16 via the interface 15. For example, the record data can be stored on the computer 16 so as to record the repositioning operation. For example, the record can be compiled in such a way that the positioning intervals carried out are stored with the patient's details and with the respective times and are transferred to the computer 16 or are stored on a storage medium, for example an SD memory card, provided in the electronic control device 11.

The inclined position or the filling time can be taught via a storage mode, which is selected via the operating field. The inclined position can also be predefined by an input at an operating field of the electronic control device. As an option, a different inclined position can be predefined for each positioning side.

A separate time may optionally be set for each lateral position time of a cycle. For example, the following may be set in a left-neutral-right cycle: The left position is to last 30 minutes, the supine position 60 minutes, and the right position 120 minutes.

The electronic control device 11 also checks whether the target inclined position has been reached within a predefined time, for example 10 minutes. If the target inclined position has not been reached within the predefined time, the control device 11 recognizes a fault and displays this fault.

In the learning mode, the control device 11 can be prompted to fill an air chamber by actuation of the pump 10, for example by pressing a programming button. If the desired inclined position is reached, the control device 11 is informed, by actuation of the programming button, that the present inclined position is to be stored as the target inclined position. The electronic control device 11 then stores the actual inclined position as the target inclined position.

FIG. 7 shows a side view of a care bed with a lateral positioning device, similarly to FIG. 1. The lateral positioning device according to FIG. 7 additionally has stabilizing plates 17, which are arranged on the rear face of the air bellows 4, 8 between the air bellows and the slatted frame 3. FIG. 8 shows the position and arrangement of the stabilizing plates 17 on the basis of a view corresponding to FIG. 3, that is to say on the basis of the example of rotation to the left of the lying surface. The stabilizing plates 17 are formed as rigid foam plates. For example, each stabilizing plate 17 may have a thickness of 3 mm with a length of 300 mm and a width of 150 mm.

FIGS. 7 and 8 also show preferably fastening areas 18 on the air bellows for the first and second sensor 7, 9, said fastening areas being arranged in the region of the shoulders of the patient 6 recumbent on the mattress 5. For example, the fastening areas 18 may be provided by a hook-and-loop strip bonded adhesively to the air bellows.

FIG. 9 shows a further embodiment of the lateral positioning device in a view similar to FIG. 6. In contrast to the embodiment of FIG. 6, in the embodiment of FIG. 9 the pump 10 is connectable on both sides, that is to say both on an intake side 90 and on a compressed air delivery side 91, to the air chambers 4, 8 via electrically actuatable valves 92, 93, 94, 95. In addition, the intake side 90 is connectable via an electrically actuatable valve 96 to the atmosphere, illustrated by an atmosphere connection point 98. The compressed air delivery side 91 is connectable via an electrically actuatable valve 97 to the atmosphere.

The compressed air delivery side 91 is connectable via a first electrically actuatable inlet valve 92 to the air chamber 4 and is connectable via a second electrically actuatable inlet valve 94 to the air chamber 8. The intake side 90 is connectable via a first electrically actuatable outlet valve 93 to the air chamber 4 and is connectable via a second electrically actuatable outlet valve 95 to the air chamber 8. The aforementioned connections are implemented as pneumatic connections, for example in the form of hoses or tubes. The electrically actuatable valves 92, 93, 94, 95, 96, 97 can each be formed as 2/2 valves, which have the function of allowing or blocking an airflow. Said valves can be formed as solenoid valves in particular. For electrical actuation, the valves 92, 93, 94, 95, 96, 97 can be connected via a respective electrical line to the electronic control device 11. The electronic control device 11 controls the valves 92, 93, 94, 95, 96, 97 individually or in combination as required.

FIG. 9 also shows an operating means 19, which is provided for manual operation of the lateral positioning device. The operating means 19 has buttons or switches 20, via which the operating commands can be input and settings can be defined. In addition, a display device 21 is provided, for example in the form of an LCD display. Operating data of the lateral positioning device can be displayed on the display device 21.

The electronic control device 11, the operating means 19, the electrically actuatable valves 92, 93, 94, 95, 96, 97 and the pump 10 are arranged in a common housing 99.

FIG. 10 shows a further embodiment of the lateral positioning device, which corresponds to the embodiment of FIG. 9 apart from the differences described below. In the embodiment according to FIG. 10, six electrically actuatable valves in the form of solenoid valves are likewise provided. However, the valves are formed as 3/2 valves in this case. Three of the valves are combined in each case to form a valve block 102, 103. As can be seen in FIG. 10, the three valves a, b, c are connected pneumatically in succession in a valve block 102, 103 so that a series connection is formed. A pneumatic connection point 104, 107 of each valve block 102, 103 provided for connection to the pump 10 is connected to the pump 10 via a pneumatic line. The valve block 102 is used to empty each of the air chambers 4, 8. The connection point 104 of the valve block 102 is therefore connected to the intake side 90 of the pump 10. The valve block 103 is used to fill each of the air chambers 4, 8. The connection point 107 of the valve block 103 is therefore connected to the compressed air delivery side 91 of the pump 10. The valve a arranged first in the series connection after the respective connection point 104 or 107 is connected to the subsequent valve b and also to the air chamber 4. The valve b is connected to the subsequent valve c and also to a respective connection point 100 or 101, connected to the atmosphere. The valve c arranged last in the series connection is connected to the air chamber 8. A further connection point of the valve c is closed by a respective stopper 100, 106.

1. A lateral positioning device for the variable lateral positioning of a recumbent person (6), said lateral positioning device comprising the following features:
a) at least one actuator (4, 8, 10, 12, 13, 14, 92, 93, 94, 95, 96, 97) acting on a mattress (5) provided as a lying surface for the person (6), wherein, by means of the actuator (4, 8, 10, 12, 13, 14, 92, 93, 94, 95, 96, 97), the angle (α_{L}, α_{R}) between the transverse axis (Q) of the mattress (5) and the horizontal (H) can be varied,
b) wherein the actuator (4, 8, 10, 12, 13, 14, 92, 93, 94, 95, 96, 97) has at least one air bellows with a right air chamber (4), a left air chamber (8) and at least one pump (10) for feeding air into the air bellows (4, 8), wherein the right air chamber (4) is designed to rotate the mattress (5) to the left by filling the right air chamber (4) with an amount of air, and wherein the left air chamber (8) is designed to rotate the mattress (5) to the right by filling the left air chamber (8) with an amount of air,
c) wherein the air bellows (4, 8) can be placed between the slatted frame and the mattress (5) of a care bed,
d) at least one sensor (7, 9) having an output signal, which represents the respective angle (α_{L}, α_{R}) between the transverse axis (Q) and the horizontal (H),
e) wherein a first sensor (7) having an output signal representing the respective angle (α_{L}) when the mattress (5) is rotated to the left and a second sensor (9) having an output signal representing the respective angle (α_{R}) when the mattress (5) is rotated to the right are provided,
f) wherein the first sensor (7) and the second sensor (9) are each formed as acceleration sensors,
g) wherein the first sensor (7) and the second sensor (9) are each arranged between the mattress (5) and the air bellows (4, 8),
h) at least one electronic control device (11), which is connected to the first and to the second sensor (7, 9) and to the actuator (4, 8, 10, 12, 13, 14, 92, 93, 94, 95, 96, 97) and is designed
i) to determine an actual inclined position from the output signal of the first and of the second sensor (7, 9),
ii) to adjust the angle (α_{L}, α_{R}) between the transverse axis (Q) of the mattress (5) and the horizontal (H) by actuating the actuator in such a way that the actual inclined position is set to a predetermined target inclined position.

2. The device as claimed in claim 1, wherein the sensor (7, 9) additionally generates an output signal which represents the respective angle (β) of the longitudinal axis (L) of the mattress (5) relative to the horizontal (H).

3. The device as claimed in claim 1, wherein the air bellows (4, 8) has a stabilizing plate (17) in a region of each of the left and right air chambers, said region being provided for the arrangement of the first and second sensor (7, 9).

4. The device as claimed in claim 3, wherein stabilizing plates (17) are formed as rigid foam plates.

5. The device as claimed in claim 3, wherein the stabilizing plates (17) are arranged on the side of the air bellows (4, 8) facing the slatted frame (3) of the care bed (1).

6. The device as claimed in claim 3, wherein the stabilizing plates (17) are connected non-releasably to the air bellows (4, 8) or are incorporated into the material of the air bellows (4, 8).

7. The device as claimed in claim 1, wherein the pump (10) is designed to suck air from the left air chamber (8) and from the right air chamber (4).

8. The device as claimed in claim 1, wherein the electronic control device (11) and the pump (10) are formed as a one-part electromechanical unit (99) with a common housing.

9. The device as claimed claim 1, wherein the first and/or the second sensor (7, 9) is/are fixed releasably to the surface of the air bellows (4, 8), for example by means of a hook-and-loop fastener fixed on the air bellows (4, 8).

10. The device as claimed in claim 1, wherein the air bellows has fastening areas (18) for the first and second sensor (7, 9), said fastening areas being arranged in the region of the shoulders of a patient (6) recumbent on the mattress (5) of a care bed.

11. The device as claimed in claim 1, wherein the air chambers (4, 8) extend in the longitudinal direction (L) of the mattress (5) over the shoulder and torso region of a patient (6), but not as far as the region of the lower legs.

12. A method for the variable lateral positioning of a recumbent person (6), said method having the following steps:
a) specification of a target inclined position relative to the transverse axis (Q) of a lying surface (5) of the person (6) and the horizontal (H),
b) actuation of an actuator (4, 8, 10, 12, 13, 14, 92, 93, 94, 95, 96, 97) to change the angle (α_{L}, α_{R}) between the transverse axis (Q) of the lying surface (5) and the horizontal (H),
c) determination of a current inclined position from the output signal of a sensor (7, 9), wherein the output signal represents the respective angle (α_{L}, α_{R}) between the transverse axis (Q) and the horizontal (H),
d) termination of the actuator actuation when the current inclined position has reached the target inclined position,
e) wherein a learning mode is additionally provided, in which the target inclined position can be stored in the electronic control device (11), and in which, by actuation of a programming button, the control device (11) is informed that a present inclined position is to be stored as the target inclined position, whereupon the electronic control device (11) stores the actual inclined position as the target inclined position.

13. The method as claimed in claim 12, wherein the person (6) is automatically repositioned from one side to the other side by means of temporal control.

14. The method as claimed in claim 12, wherein the target inclined position is varied automatically within a predefined range starting from a start value, in particular in accordance with a random pattern.

15. The method as claimed in claim 14, wherein the electronic control device (11) automatically sets, within predefined limit values, different target inclined positions having different position times.

16. The method as claimed in claim 14, wherein the target inclined positions and/or position times, which are set automatically by the electronic control device (11), are determined by means of a random number generator.

17. The method as claimed in claim 12, wherein the angle (α_{L}, α_{R}) set by the actuator (4, 8, 10, 12, 13, 14, 92, 93, 94, 95, 96, 97) is automatically limited to a maximum value.

18. The method as claimed in claim 12, wherein a settable starting position of the target inclined position can be programmed and the electronic control device (11) re-sets the starting position by means of the actuator (4, 8, 10, 12, 13, 14, 92, 93, 94, 95, 96, 97) after a predefined time after a manual change to the target inclined position.

19. The method as claimed in claim 12, wherein an intensive program is provided in the electronic control device (11) and is designed for use in intensive care, the electronic control device (11) only actuating the actuator (4, 8, 10, 12, 13, 14, 92, 93, 94, 95, 96, 97) as a result of manual actuations at an operating means (19) of the lateral positioning device.
